(19) United States
(12) Patent Application Publication
(10) Pub. No.: US 2022/0171848 A1
(43) Pub. Date: Jun. 2, 2022

(54) System and Method for Synthesizing Dynamic Ensemble-Based Defenses to Counter Adversarial Attacks

(71) Applicant: University of South Carolina, Columbia, SC (US)

(72) Inventors: Biplav Srivastava, Chapin, SC (US); Ying Meng, Columbia, SC (US); Jianhai Su, West Columbia, SC (US); Pooyan Jamshidi Dermani, Columbia, SC (US); Jason M. O'Kane, Columbia, SC (US)

(73) Assignee: University of South Carolina, Columbia, SC (US)

(21) Appl. No.: 17/487,502

(22) Filed: Sep. 28, 2021

Related U.S. Application Data
(60) Provisional application No. 63/119,032, filed on Nov. 30, 2020.

(51) Int. Cl. G06F 21/55

(52) U.S. Cl. CPC G06F 21/552; G06F 2221/034

(57) ABSTRACT

A method and device for synthesizing adaptive defenses of artificial intelligence (AI) systems against adversarial attacks. The method comprises, during a design phase, creating a library of weak defenses (WDs); preprocessing the WDs in the library; selecting a subset W of WDs from the WDs in the library; and, during a deployment phase, synthesizing an ensemble strategy based on an input of the selected subset W of WDs, the ensemble strategy used as a defense against adversarial attacks.

### CROSS REFERENCE TO RELATED APPLICATION

This application claims priority to U.S. Provisional Patent Application No. 63/119,032, filed on Nov. 30, 2020, entitled Synthena: A Method for Synthesizing Dynamic Ensemble-Based Defenses to Counter Adversarial Attacks, the disclosure of which is incorporated by reference.

This embodiments in this disclosure were made with government support under 80NSSC19M0050 awarded by NASA. The government may have certain rights in this disclosure.

### BACKGROUND

### Field

The present disclosure relates to new methods for ensemble-based AI defenses, which given a limit on ensemble size and a set of choices, selects a subset of weak-defenses dynamically from the choices satisfying the ensemble constraints and diversity between the constituent defenses and if any constituent defense in the ensemble is deselected or becomes unavailable, the ensemble can be recreated where the ensemble's quality is measured by a new metric, i.e., its diversity.

### Description of Related Art

Learning-based systems are prone to adversarial attacks undermining the robustness of using Artificial Intelligence (AI) and Machine Learning (ML) in mission critical systems such as self-driving cars. Since the robustness of ML models is a major practical concern for its wide-spread adoption, many defense methods have been proposed for adversarial attacks. There are many algorithms to defend adversarial attacks. A new trend in building effective defenses is to consider an ensemble of weak defenses (WD)s. All existing adversarial defenses are static, meaning that the defense cannot be changed at deployment time. The current disclosure is the first dynamic defense that change the structure and behavior of the defense to counter change of behavior of the adversarial attackers.

Previous work includes input transformation to diminish the impact of AEs by restricting the space of AEs. These attempts include, for example, Countering adversarial images using input transformations, Chuan Guo et al. 2018, In Proceedings of the ICLR, https://openreview.net/pdf?id=SyJ7ClWCb, which suggests the use of several transformations as a pre-processing step to a convolutional image classifier. Defending against adversarial images using basis functions transformations, Uri Shaham et al. 2018, https://arxiv.org/pdf/1803.10840.pdf, discusses experimentation with some transformations as a pre-processing step and found that all transformations provide some robustness against strong white-and-black-box attacks. Improving adversarial robustness by data-specific discretization, Jiefeng Chen et al. 2018, https://www.semanticscholar.org/paper/Improving-Adversarial-Robustness-by-Data-Specific-Chen-Wu/107a53a46f3acda939d93c47009ab960d6a33464, discusses masking the gradients via a pre-processing technique. Detecting adversarial examples in deep networks with adaptive noise reduction, Bin Liang et al. 2017, https://arxiv.org/pdf/1705.08378.pdf, treated adversarial perturbations as noise and then mitigated the threats via noise reduction methods. Blind pre-processing: A robust defense method against adversarial examples, Adnan Siraj Rakin et al. 2018, https://arxiv.org/pdf/1802.01549.pdf, discusses processing the input using a combination of methods and combining the pre-processing with adversarial training. However, the above work differs from the current disclosure by providing only single model defenses that lack dynamic synthesis at various levels, as described herein.

Further efforts include adversarial training involving AEs in the training data set as a form of regularization. Explaining and harnessing adversarial examples, Ian Goodfellow et al., 2015, In Proceedings of the ICLR, https://arxiv.org/pdf/1412.6572.pdf shows adversarial training with the FGS attack as regularizer. A unified gradient regularization family for adversarial examples, Chunchuan Lyu et al. 2015, In Proceedings of the ICDM. IEEE. https://reeexplore.ieee.org/abstract/document/7373334, discusses adversarial training with abstractions from a family of gradient-based perturbations as regularization. Towards deep learning models resistant to adversarial attacks, Aleksander Madry et al. 2018, In Proceedings of the ICLR, https://arxiv.org/pdf/1706.06083.pdf, discusses adversarial training using PGD for the inner maximization problem which resulted in a very well-concentrated loss values. These works also lack various facets of the current disclosure including only using single model defenses, lacking dynamic synthesis at various levels, and requiring careful selection of regularization methods instead of disclosing a synthesizing diverse ensemble that counteracts dynamic adversarial attacks.

Additional efforts include certified defenses that hold the robustness within the bounds for the training data set via formal verification techniques. Reluplex: An efficient SMT solver for verifying deep neural networks, Guy Katz et al. 2017, In Proceedings of the CAV. Springer, https://link.springer.com/chapter/10.1007/978-3-319-63387-9_5, uses SMT solvers to verify robustness constraints for DNNs with ReLU activations, by adapting the Simplex algorithm with rules for non-convex optimization. Formal verification of piece-wise linear feed-forward neural networks, Ruediger Ehlers et al. 2017, In Proceedings of the ATVA. https://arxiv.org/pdf/1705.01320.pdf, uses SMT solvers to verify robustness constraints for DNNs with ReLU activations, by using linear approximation to over-approximate the model's behavior. Provably minimally-distorted adversarial examples, Nicholas Carlini et al. 2018, arXiv:1711.00851 https://arxiv.org/pdf/1709.10207.pdf, uses ReLUs to verify p1 and p∞ norm adversarial examples by encoding absolute values. Safety verification of deep neural networks, Xiaowei Huang et al. 2017 In Proceedings of the CAV. Springer, https://arxiv.org/pdf/1610.06940.pdf, exhaustively searches for perturbations in a given norm ball at each layer of DNNs. These efforts, although providing guarantees, cannot extend to large practical models that are required for real world scenarios.

Others have employed dynamic approaches. Mitigating adversarial effects through randomization, Cihang Xie et al. 2018, In Proceedings of the ICLR, https://arxiv.org/pdf/1711.01991.pdf, uses 2 simple randomization operations—(1) randomly resizing the input images and (2) randomly padding zeros around the input—to diminish adversarial perturbations. Stochastic activation pruning for robust adversarial defense, Guneet S. Dhillon et al. 2018, arXiv:1803.01442, https://arxiv.org/pdf/1803.01442.pdf, solves a min-max zero-sum game, which prunes a random subset of activations and scales up the survivors to compensate, between adversary and the model. Certified Adversarial Robustness via Randomized Smoothing Jeremy M. Cohen et al. 2019, In Proceeding of the ICLR. https://arxiv.org/pdf/1902.02918.pdf, generates a set of Gaussian noisy images for the input and produces the final label for the input using majority-voting strategy on the predictions for the noisy images. In Barrage of Random Transforms for Adversarially Robust Defense, Edward Raff et al. 2019. CVPR 2019, https://ieeexplore.ieee.org/document/8954476, random numbers of transformations are applied on an input in a random order prior to prediction.

These approaches, too, lack aspects of the current disclosure and employ randomizations as dynamism which becomes ineffective in scenarios where the adversaries change their behavior dramatically that counteracts such weak randomizations of the input data.

Other dynamic approaches have been proposed and implemented. For example, A previous study [Xie, Zhang, and Yuille 2017] introduced the dynamics in the training phase, where two simple randomization operations are performed during training: (1) randomly resize the input images and (2) randomly pad zeros around the input, were used to diminish adversarial perturbations. The dynamics can also be applied at test time. The study [Jeremy M Cohen and Kolter 2019] improves model's robustness by generating a set of Gaussian noisy images for the input and producing the final label for the input using a majority-voting based strategy on the predictions on the noisy images. However, such dynamics only happen either during training or testing and the randomness in these approaches will bring variations to the effectiveness of defense. While in the approach in the current disclosure, synthesis happens at several levels (design phase and/or test phase) and the defense is synthesized with heuristic guidance.

Some efforts have been made at ensemble defenses. Ensemble adversarial training: Attacks and defenses, Florian Tramer et al. 2017, arXiv:1705.07204 https://arxiv.org/pdf/1705.07204.pdf, augments training data with adversarial examples crafted based on other models and trains with ensemble methods aiming to increase the diversity of seen perturbations therefore improved the generalization ability. Improving Adversarial Robustness via Promoting Ensemble Diversity, Tianyu Pang et al. 2019, In Proceedings of the 36th International Conference on Machine Learning, http://proceedings.mlr.press/v97/pang19a/pang19a.pdf, trains an ensemble defense with an additional regularization term, which encourages the ensemble diversity on non-maximal predictions. Improving Adversarial Robustness of Ensembles with Diversity Training, Sanjay Kariyappa et al. 2019, arXiv:1901.09981 https://arxiv.org/pdf/1901.09981.pdf, proposes the gradient alignment loss (GAL) and uses the diversity of gradients in the ensemble to improve the robustness. These efforts also fail to provide the defense regime disclosed herein. They typically employ a design time/static approach, which provides weak defenses that cannot change after deployment.

Until the current disclosure, explained infra, ensemble methods were static and could not be changed. The current disclosure provides techniques for building dynamic ensemble defenses and showing effectiveness of such ensembles over current approaches. This disclosure provides embodiments for adversarial defenses in the AI domain that are adaptive and effective to ever-increasing adversarial attacks. Accordingly, it is an object of the present disclosure to provide new methods for ensemble-based defenses. As discussed in this disclosure, dynamic synthesis is allowed at the design and deployment phases, and each individual weak defense can be updated/replaced at any stage and adapted as the attack continues.

### SUMMARY OF THE DISCLOSURE

The above objectives are accomplished according to the present disclosure by providing, in one aspect of the disclosure, methods and systems for adaptive defense of AI systems against adversarial attacks. Further, the current disclosure provides a system to create dynamic defenses for adversarial attacks on AI systems, the steps comprising taking a library of WDs, providing constraints on ensemble size and inter-WD diversity metrics, generating an ensemble consistent with the constraints, monitoring the performance of the AI system at deployment time, and dynamic adaptation of the defense on the fly. In one embodiment, the WDs are discovered dynamically. In another embodiment, the WDs are selected dynamically. This ensemble strategy is also learned and adapted dynamically.

The current disclosure also provides a method to run and dynamically adjust ensembles of defenses for adversarial attacks on AI systems comprising dynamic learning of ensemble strategies and dynamic re-deployment of new ensembles based on the change of the behavior of users and performance monitoring of the ensemble defense. Further, the ensemble is monitored for performance and continuously improved and adapted based on the performance behavior of the system.

In accordance with an embodiment of one aspect of the present disclosure, a method is provided to run and dynamically adjust ensembles of defenses for adversarial attacks on artificial intelligence (AI) systems comprising dynamically learning ensemble strategies and dynamically re-deploying new ensemble strategies based on a change of behavior of users monitoring of the ensemble defense

In accordance with an embodiment of another aspect of the present disclosure, a method for synthesizing adaptive defenses of AI systems against adversarial attacks is provided, the method including: during a design phase, creating a library of weak defenses (WDs); preprocessing the WDs in the library; selecting a subset W of WDs from the WDs in the library; and during a deployment phase, synthesizing an ensemble strategy based on an input of the selected subset W of WDs, the ensemble strategy used as a defense against adversarial attacks.

In another embodiment of this aspect, the method further includes, in the deployment phase, monitoring, via a monitoring and feedback mechanism, a run-time performance of the defense. In another embodiment, the method further includes re-synthesizing the ensemble. In another embodiment, the WDs are discovered dynamically. In another embodiment, the WDs are selected dynamically.

In another embodiment of this aspect, the method further includes maintaining the library of WDs by at least one of adding new WDs, updating existing WDs and removing ineffective WDs. In another embodiment, preprocessing the WDs includes grouping the WDs in accordance with their transformation operations. In another embodiment, prepreocessing the WDs includes storing the WDs in a list. In another embodiment, preprocessing the WDs in the library comprises clustering the WDs in accordance with a clustering algorithm.

In another embodiment of this aspect, the clustering algorithm is one of a hierarchical clustering or a k-means clustering. In another embodiment, selecting a subset W of WDs from the WDs in the library comprises employing a heuristic search. In another embodiment, selecting a subset W of WDs from the WDs in the library is dependent upon how the WDs in the library are preprocessed. In another embodiment, the monitoring and feedback mechanism includes a monitor component, a judge component, and a messenger component.

In accordance with an embodiment of another aspect of the present disclosure, a device for synthesizing adaptive defenses of artificial intelligence (AI) systems against adversarial attacks, is provided. The system includes a processor and a memory, the memory containing instructions executable by the processor, the processor configured to create a library of weak defenses (WDs); during a design phase, preprocess the WDs in the library; select a subset W of WDs from the WDs in the library; and during a deployment phase, synthesize an ensemble strategy based on an input of the selected subset W of WDs, the ensemble strategy used as a defense against adversarial attacks.

In accordance with another embodiment of this aspect, the processor is further configured to, in the deployment phase, monitor, via a monitoring and feedback mechanism, a run-time performance of the defense. In another embodiment, the processor is further configured to re-synthesize the ensemble. In another embodiment, the WDs are discovered dynamically. In another embodiment, the WDs are selected dynamically. In another embodiment, the processor is further configured to maintain the library of WDs by at least one of adding new WDs, updating existing WDs and removing ineffective WDs. In another embodiment, preprocessing the WDs includes grouping the WDs in accordance with their transformation operations. In another embodiment, prepreocessing the WDs includes storing the WDs in a list. In another embodiment, preprocessing the WDs in the library includes clustering the WDs in accordance with a clustering algorithm.

In another embodiment of this aspect, the clustering algorithm is one of a hierarchical clustering or a k-means clustering. In another embodiment, selecting a subset W of WDs from the WDs in the library includes employing a heuristic search. In another embodiment, selecting a subset W of WDs from the WDs in the library is dependent upon how the WDs in the library are preprocessed. In another embodiment, the monitoring and feedback mechanism includes a monitor component, a judge component, and a messenger component.

### BRIEF DESCRIPTION OF THE DRAWINGS

The construction designed to carry out the methods and systems of the present disclosure will hereinafter be described, together with other features thereof. The present disclosure will be more readily understood from a reading of the following specification and by reference to the accompanying drawings forming a part thereof, wherein an example of the present disclosure is shown and wherein:

FIG. 1 shows U is the universe of all possible image transformations, a subset P of WD candidates are chosen for building ensembles, and any non-empty subset E in P is a WD ensemble, in accordance with embodiments of the present disclosure;

FIG. 2 shows Table 1, listing transformations, in accordance with embodiments of the present disclosure;

FIG. 3A shows a system architecture of synthesizing an ensemble defenses in accordance with embodiments of the present disclosure;

FIG. 3B shows features of the monitor and feedback system in accordance with embodiments of the present disclosure;

FIG. 4A shows trial results of evaluations of AVEP ensembles of various sizes in accordance with embodiments of the present disclosure;

FIG. 4B shows additional trial results of evaluations of AVEP ensembles of various sizes in accordance with embodiments of the present disclosure;

FIG. 4C shows still additional trial results of evaluations of AVEP ensembles of various sizes in accordance with embodiments of the present disclosure;

FIG. 5 shows sample pre-processing cases in accordance with embodiments of the present disclosure; and

FIG. 6 shows a device for synthesizing dynamic ensemble-based defenses to counter adversarial attacks.

It will be understood by those skilled in the art that one or more aspects of this disclosure can meet certain objectives, while one or more other aspects can meet certain other objectives. Each objective may not apply equally, in all its respects, to every aspect of this disclosure. As such, the preceding objects can be viewed in the alternative with respect to any one aspect of this disclosure. These and other objects and features of the disclosure will become more fully apparent when the following detailed description is read in conjunction with the accompanying figures and examples. However, it is to be understood that both the foregoing summary of the disclosure and the following detailed description are of a preferred embodiment and not restrictive of the disclosure or other alternate embodiments of the disclosure. In particular, while the disclosure is described herein with reference to a number of specific embodiments, it will be appreciated that the description is illustrative of the disclosure and is not constructed as limiting of the disclosure. Various modifications and applications may occur to those who are skilled in the art, without departing from the spirit and the scope of the disclosure, as described by the appended claims. Likewise, other objects, features, benefits and advantages of the present disclosure will be apparent from this summary and certain embodiments described below, and will be readily apparent to those skilled in the art. Such objects, features, benefits and advantages will be apparent from the above in conjunction with the accompanying examples, data, figures and all reasonable inferences to be drawn therefrom, alone or with consideration of the references incorporated herein.

### DETAILED DESCRIPTION OF A PREFERRED EMBODIMENT

With reference to the drawings, the present disclosure will now be described in more detail. Unless defined otherwise, all technical and scientific terms used herein have the same meaning as commonly understood to one of ordinary skill in the art to which the presently disclosed subject matter belongs. Although any methods, devices, and materials similar or equivalent to those described herein can be used in the practice or testing of the presently disclosed subject matter, representative methods, devices, and materials are herein described.

Unless specifically stated, terms and phrases used in this document, and variations thereof, unless otherwise expressly stated, should be construed as open ended as opposed to limiting. Likewise, a group of items linked with the conjunction “and” should not be read as requiring that each and every one of those items be present in the grouping, but rather should be read as “and/or” unless expressly stated otherwise. Similarly, a group of items linked with the conjunction “or” should not be read as requiring mutual exclusivity among that group, but rather should also be read as “and/or” unless expressly stated otherwise.

Furthermore, although items, elements or components of the disclosure may be described or claimed in the singular, the plural is contemplated to be within the scope thereof unless limitation to the singular is explicitly stated. The presence of broadening words and phrases such as “one or more,” “at least,” “but not limited to” or other like phrases in some instances shall not be read to mean that the narrower case is intended or required in instances where such broadening phrases may be absent.

Throughout this application, various embodiments of this present disclosure may be presented in a range format. It should be understood that the description in range format is merely for convenience and brevity and should not be construed as an inflexible limitation on the scope of the present disclosure. Accordingly, the description of a range should be considered to have specifically disclosed all the possible subranges as well as individual numerical values within that range. For example, description of a range such as from 1 to 6 should be considered to have specifically disclosed subranges such as from 1 to 3, from 1 to 4, from 1 to 5, from 2 to 4, from 2 to 6, from 3 to 6 etc., as well as individual numbers within that range, for example, 1, 2, 3, 4, 5, and 6. This applies regardless of the breadth of the range.

Whenever a numerical range is indicated herein, it is meant to include any cited numeral (fractional or integral) within the indicated range. The phrases “ranging/ranges between” a first indicate number and a second indicate number and “ranging/ranges from” a first indicate number “to” a second indicate number are used herein inter-changeably and are meant to include the first and second indicated numbers and all the fractional and integral numerals therebetween.

A new and emerging category of defenses to adversarial attacks on AI are ensemble-based defenses. An example is Athena, which creates an ensemble from many diverse weak defenses (WD). The current disclosure proposes a new method for ensemble-based defenses which, given a limit on ensemble size and a set of choices, selects a subset of weak-defenses dynamically from the choices satisfying the ensemble constraints and diversity between the constituent defenses. If any constituent defense in the ensemble is deselected or becomes unavailable, the ensemble can be recreated. The ensemble's quality is measured by a new metric, its diversity. The “dynamic” aspects of the defense (e.g., dynamic selection of constituent weak defenses, dynamic changes in the ensemble strategy) provides a mechanism designed to counter the changes in the behavior of the adversarial attackers at deployment time.

The current disclosure provides the benefits of smaller ensembles without compromising effectiveness of defense, uses less resources, and provides ensembles that are adaptive to real-time attacks.

A summary of the features for building an adaptive defense, which evolves over time, as provided by the present disclosure, includes: (1) building of ensemble defenses from WDs; (2) dynamic discovery and optimization of WDs; (3) dynamic selection of WDs; (4) dynamic learning of the ensemble strategy; and (5) monitoring and feedback on ensembles for continuous improvement.

In one embodiment, the current disclosure provides a method for synthesizing dynamic ensemble-based defenses to counter adversarial attacks that provides for dynamic selection of WDs. Inputs may include but are not limited to a library of classifiers, for purposes of example and not intended to be limiting, five (5) CNN classifiers that are associated to rotate 90 degrees, Gaussian noise, feature_std_norm, denoise_nl_means_fast, geo_swirl, etc., such that the ensemble is the most robust of all possible combinations from the library. The current disclosure also allows for a dynamic learning ensemble strategy, wherein inputs include but are not limited to: the ensemble consisting of WDs: feature_std_norm, denoise_nl_means_fast, geo_swirl, predictions from WDs on the input data, and generating a set of ensemble strategies including majority-voting and averaging-predictions. Outputs may include but are not limited to a strategy of averaging-predictions from WDs, and producing the final label of the input data. The current disclosure includes building ensemble defenses from WDs, providing dynamic discovery and optimization of WDs, providing dynamic selection of WDs, providing dynamic learning of the ensemble strategy, and monitoring and providing feedback on the ensemble for continuous improvement.

Ensemble Creation may include as inputs: a library L of weak defenses (WDs) with model type (e.g., SVM, CNN), model architecture (e.g., layers, # neuros), model parameters, loss functions, etc., constraints on ensemble size and diversity, and ensemble strategy. Outputs may include an ensemble E satisfying ensemble constraints. The steps for this may include creating E from scratch by selecting a (random) WD from library L, measure the quality of E using diversity metrics, while E cannot be further improved, expand E by selecting another WD; and ensuring the quality of E.

Dynamic WD Discovery and Optimization may include for inputs: a library L of WDs with model type (e.g., SVM, CNN), model architecture (e.g., layers, # neuros), model parameters, loss functions, etc., and samples sent to the ensemble E over a given period T. The outputs may include a new library of WDs that can lead an optimal ensemble with better diversity with respect to the collected samples over the period T. This may include after every period T, evolving the library of WDs with respect to the change of sample distribution in the period T such that the upper bound of ensemble performance is not deteriorated.

Dynamic Selection of WDs may include for inputs, a library L of WDs with model type (e.g., SVM, CNN), model architecture (e.g., layers, # neuros), model parameters, loss functions, etc., constraints on ensemble size and diversity, ensemble strategy, and samples sent to the ensemble E over a given period T. Outputs may include an ensemble E′ satisfying ensemble constraints. Steps for this may include Cluster L into C groups, where the WDs in the same group are more similar than the WDs from different groups, creating E′ from scratch by selecting a (random) WD from a cluster, extending E′ by searching across clusters then WDs, measuring quality of E′ using diversity metrics with collected samples over the period T, while E′ cannot be further improved, expanding E′ by selecting another WD, and measuring the quality of E′.

Dynamic Learning of Ensemble Strategy may include, for input, a library L of WDs with model type (e.g., SVM, CNN), model architecture (e.g., layers, # neuros), model parameters, loss functions, etc., constraints on ensemble size and diversity, a set of valid ensemble strategies, and samples sent to the ensemble E over a given period T. Outputs may include an ensemble E′ satisfying ensemble constraints. Steps for this may include computing the performance of each valid ensemble strategy with L and the collected samples over the period T and returning the ensemble E′ that gives the best performance.

Monitoring and Feedback on the ensemble may include for inputs the deployed ensemble and predictions from the ensemble on the input data. Outputs may include a signal whether the ensemble needs to be updated (i.e., whether to re-synthesize a new ensemble) at any level. If yes, then the synthesis process is triggered. Steps for the above may include automatically and/or manually monitoring the input-prediction pairs of the ensemble after deployment and triggering the synthesis of ensemble if the ensemble did not work well at test time.

The current disclosure provides the benefits of: smaller ensembles without compromising effectiveness of a defense; created ensemble-defenses using less resources to execute than alternatives like random ensembles; a tradeoff between test-time overhead and robustness; and ensembles that are adaptive to real-time attacks and that adapt to change of behavior of the attackers.

Other aspects of the current disclosure include a metric to measure quality of the ensemble; iteratively searching for candidate WDs in the space of possible WDs and adding selectively in the ensemble; monitoring and adapting the ensemble periodically; learning ensemble strategies dynamically; and dynamic synthesis of ensembles.

Due to their state-of-the-art performance, machine learning systems have been applied in a wide variety of domains, such as image classification, speech recognition, and machine translation. However, since it was discovered that deep learning models are highly vulnerable to adversarial attacks, the study on adversarial machine learning has gained a significant amount of attention. New adversarial attack and defense methods have been proposed in recent years. The existing defense methods, either by modifying inputs during training (e.g., adversarial training), testing (e.g., randomized smoothing), introducing randomness, or by modifying the model (e.g., defensive distillation), are determined at design time and lack adaptation during testing. However, none of these existing defense mechanisms could serve as a one-stop solution for all types of adversarial attacks.

The current disclosure opens a new direction to adversarial defense by dynamically synthesizing the defense at design time and automatically re-synthesizing the defense at deployment time on the fly based on the change in the behavior of the users of the system.

Previous studies have shown that it is possible to construct an ensemble defense with many diverse WDs that is effective against various adversarial attacks. In these studies, each individual WD is a defense based on a transformation (the terms WD and transformation may be used interchangeably)—an image processing function such as rotation, so, any non-empty subset in the entire spectrum of image manipulations can result in an ensemble model. For simplicity, some transformations from various types were selected and for each type, variants were implemented. For example, the inputs were rotated by 90, 180, and 270 degrees. Hereafter, we will refer to a variant (e.g., rotation by 90 degrees) as a “transformation.”

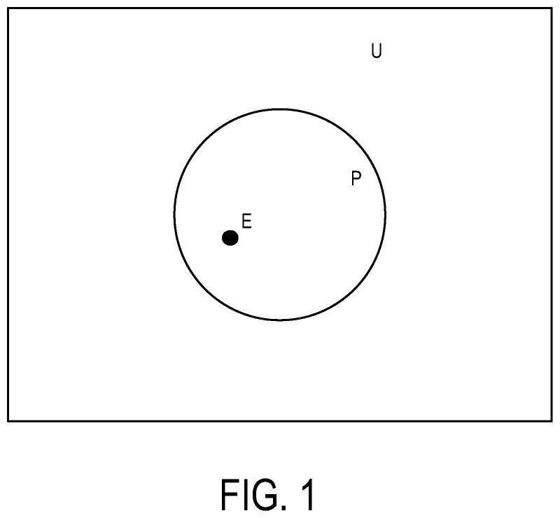

Referring now to FIG. 1, it is assumed that there are N (N could be infinite) possible transformations in total (the rectangle U in FIG. 1). From that, a subset of n transformations are chosen for building the ensemble (the circle P). Then, there are

$${C}_{n}^{N} = \frac{N !}{n ! ( N - n ) !}$$

possible ways to choose this subset P from U. Any non-empty subset in P is an ensemble (the dot E), therefore given a P, there are 2^{K}−1 possible ways to select E (let K=Cₙ^{N}). In the aforementioned study, the authors built the ensemble model with a fixed list of transformations (i.e., they built the ensemble using the entire subset P), therefore, only one out of

$$2 \frac{N !}{n ! ( N - n ) !}$$

possible ensembles was examined, leaving numerous possible ensembles untested, among which a more robust ensemble may exist.

This disclosure relates to the infinite untested areas (i.e., the rectangle and circle areas), where an efficient ensemble may reside. A single ensemble is static, which is likely to be fooled by the adversarial examples (AEs) generated by unseen attacks. The proposed defense in this disclosure is dynamically synthesized at the design phase and is able to be adaptive at the test phase. Therefore, any dot (ensemble) in U could be the ensemble currently in use, which further makes it very difficult or even infeasible for attackers to fool.

The present disclosure provides a new way to construct adversarial defenses—automatic synthesis of ensembles. The present disclosure discusses the feasibility of synthesizing ensembles via the implementation of a simple sub-task with strong constraints and the results of experiments on MNIST and CIFAR-100.

### Notations

In the present disclosure, we define the legitimate data set D as a collection of K input-output pairs, where {(x₁, [symbol] ₁), . . . , (x_{K}, [symbol] _{K})}, where xᵢ∈ [symbol] ^{d}^{^{−}} is an input with the corresponding output [symbol] ᵢ∈ [symbol] where [symbol] ={0, 1, . . . , c} is the set of indices of all classes.

The present disclosure focuses on supervised machine learning, where a classifier is a function ƒ: x [symbol] p, taking x∈ [symbol] ^{d} as the input and the output a vector p of probabilities of all the classes in C and argmax(p)=y.

A library of WDs is denoted as [symbol] . The library of WDs that have been pre-processed is denoted as [symbol] *. The subset of WDs that are used to build the ensemble is denoted as W.

### Transformation

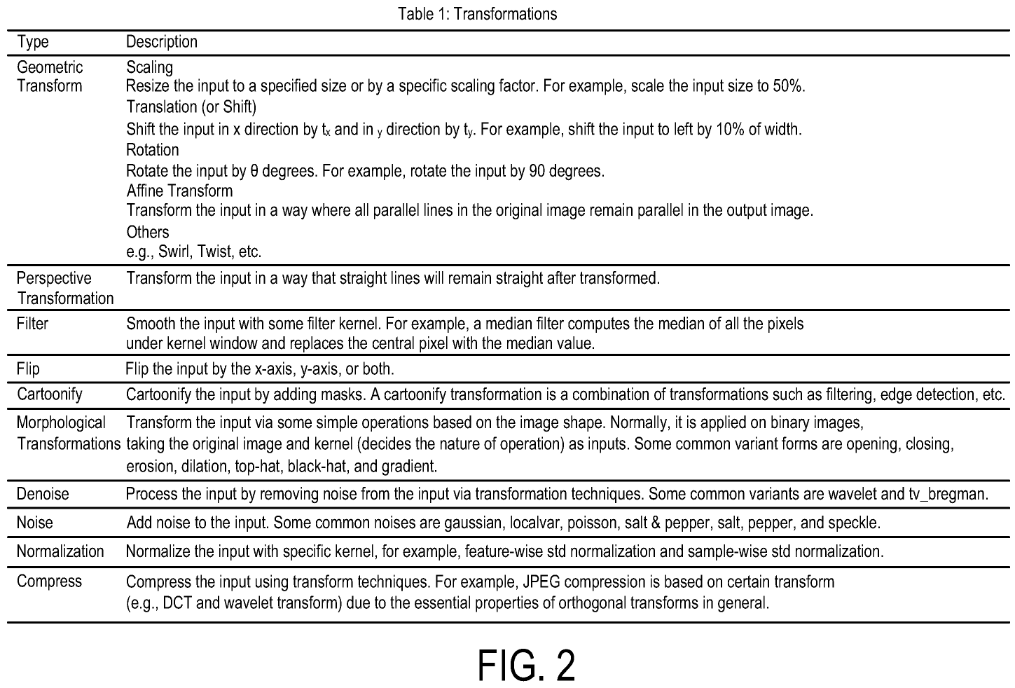

A transformation is a function that maps one set to another set via some operations. An image transformation maps an image in one domain to an image in another domain. The present disclosure focuses on image classification tasks, therefore, when transformation are mentioned, it refers to image transformation. There are many types of transformations and each can have a large amount of variants, see FIG. 2 Table 1. For example, for rotation, an input can be rotated by any degree. In the present disclosure, a variant of a transformation type is referred to as transformation for simplicity.

### Adversarial Attack

Adversarial example (AE) generation can be performed both in the training and testing phases. Poisoning attacks alter the training data set by injecting malicious samples that subsequently challenge the model's integrity. Evasion attacks are the most prevalent attacks, where an adversary aims to evade detection by manipulating malicious test samples. The present disclosure focuses only on evasion attacks.

An adversarial attack method attempts to generate an adversarial example (AE) x0 (limited in lp-norm) by solving an optimization to maximize the loss function:

$${max}_{δ} ( J ( f , x + δ , {y}_{true} ) ) , \\ whereby {‖ δ ‖}_{p} \leq c and {x}^{′} = x + δ ∈ {[ 0 , 1 ]}^{D} , \qquad ( 1 )$$

where ƒ is the targeted model, x is an input with a ground truth output [symbol] ₜᵣᵤₑ, δ, is the adversarial perturbation with a magnitude of ϵ. The AE x′ is constrained within an lₚ ball of benign sample (BS) x in order to remain imperceptible. Different norms are used by different attacks.

Many attacks were implemented based on the gradient of the cost function with respect to the input of the model. Some attacks generate the AE in only one iteration, such as FGSM, where an AE was generated using equation 2:

where J is the cost function of the trained model, ∇x is the gradient with respect to the input x with corresponding true output y, and ϵ is the magnitude of the perturbation.

Other variations such as BIM and PGD generate AEs gradually increase the magnitude until the input is misclassified. For example, rather than taking one big jump ϵ, BIM takes multiple smaller steps α>ϵ with the result clipped by ϵ. Specifically, BIM begins with x′₀=x, and at each iteration it performs:

x′ᵢ=_{x,ϵ}{x′ᵢ₋₁−(α·sign(∇ₓJ(x′ᵢ₋₁, [symbol] ))}, (3)

where clip_{x,ϵ}(A) denotes the element-wise clipping of x; the range of A after clipping will be

JSMA greedily finds the most sensitive direction, such that changing its values will significantly increase the likelihood of a target model labeling the input as the target class:

where sₜ represents the Jacobian of target class t∈ [symbol] with respect to the input image, and where sₒ is the sum of Jacobian values of all non-target classes.

CW constraints AEs to stay within a certain distance from the benign example. DEEPFOOL takes iterative steps to the direction of the gradient of a linear approximation of the target model.

Both attacks generate adversarial examples by solving an optimization problem like:

argmin(d(s,x+δ)+c· [symbol] (x+δ)), (5)

where [symbol] is the loss function for solving ƒ(x+δ)=t and t∈ [symbol] is the target label.

Black-box attacks do not require any knowledge of target models, yet are shown to be effective in fooling machine learning models. ONE-PIXEL, one of the extreme adversarial attack methods, generates adversarial examples using an evolutionary algorithm called Differential Evolution.

### Defense

A defense is a method aiming to correctly predict an AE, i.e., argmax ƒ(x′)=yₜᵣᵤₑ.

Recently, defenses have been studied extensively. Many defenses have been developed along different strategies. Adversarial training, one of the most common defense strategies in recent years, improves a model's robustness by injecting adversarial examples into the training data set while training the targeted model. However, such defense strategy has been shown not to be robust against black-box attacks, where an attacker crafts adversarial examples on a locally trained surrogate model. Also, previous studies show that a two-step attack, where introducing random perturbations other than any classical adversarial perturbations into an input, can easily bypass the adversarial training defense.

Gradient-based attacks could consist of hiding information about the targeted model's gradient from the adversary and a natural adversarial defense approach could hide a model's gradient. However, such a method would also double the training complexity of the network. Moreover, this defense is easily fooled by black-box attacks where the gradient of the locally trained surrogate model is accessible. Certified defenses hold the robustness within the bounds for the training data set via formal verification techniques, for example SMT solvers. However, such approaches require sound background in both machine learning and software security areas and therefore are difficult to implement.

Although the above defenses improve the models' robustness, they are all static approaches, which, once trained, could not be changed after being deployed. The present disclosure proposes a dynamic auto-synthesis ensemble approach, which is able to be adaptive after being deployed.

### Synthesizing Dynamic Adversarial Defenses

The current disclosure relates to the process of synthesizing ensemble defenses. Given an input, an ensemble first collects predictions from all the WDs in the input and then determines a final output using an ensemble strategy. An ensemble strategy defines how the ensemble utilizes the outputs from WDs and determines the final output. For example, the ensemble can produce the output by averaging predictions (AVEP) from WDs or by returning the output that is agreed on most by WDs (a.k.a., Majority-Voting, or “MV”). In this approach, synthesis can happen at several stages and the synthesis problem of this system can be defined as a search problem in a space of WDs over 2 orthogonal and interrelated search spaces: transformation and ensemble strategy.

The synthesis of transformation includes the search in transformation types (e.g., rotation, shift, Gaussian noising, etc.) and configurations (e.g., the degrees to rotate for a rotation transformation). For ensemble strategy, a search is performed over the strategy space for the ensemble strategy that can utilize the WDs' outputs the best. The search in transformations and in ensemble strategies are interdependent. For example, given an ensemble, AVEP strategy could output a different label from the one returned by MV strategy. As they utilize the outputs from WDs in different ways, different strategies have their own preferences in WDs. Therefore, this disclosure splits the search space into two to make the synthesis tractable.

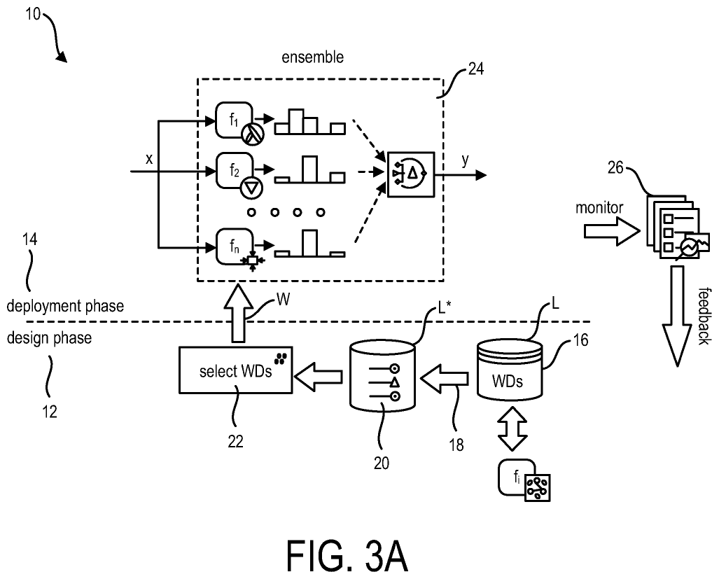

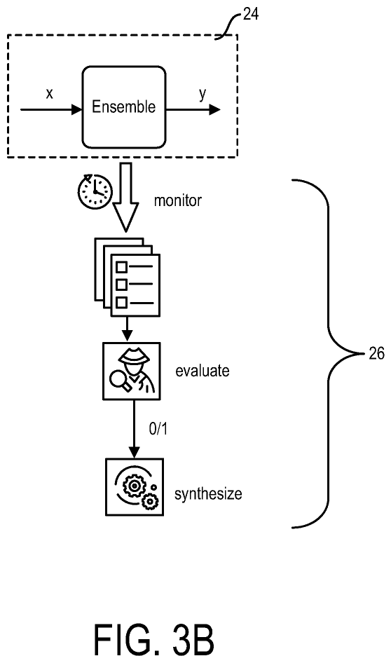

FIG. 3A presents an overview of the architecture 10 of the synthesis of ensembles in accordance with embodiments of the present disclosure. The synthesis system consists of two phases—a design phase 12 and a deployment phase 14. At the design phase 12, a library ( [symbol] ) of WDs 16 is created, updated, and maintained. Each individual WD 16 in the library is trained independently on the training set D. A preprocessing step 18 is then applied on the WDs 16 in the library, which provides a library of processed WDs 20 ( [symbol] *) in preparation for the next step, which is WD selection 22. In this step, a heuristic search is used to seek a subset of processed WDs 20. The selected subset of WDs is denoted as W.

An ensemble strategy (ES) is synthesized via a search over the strategy space or by learning a new model at step 24. At this stage, an ensemble defense is ready to be deployed. A monitor and feedback mechanism (MF) 26 is activated at the deployment phase to track and evaluate the run-time performance of the defense and trigger the re-synthesis of the ensemble, if for example, the run-time data distribution is too far from that of the training data. Detailed descriptions regarding each component are discussed below.

Library Maintenance A variety of individual WDs 16, where each individual WD 16 is associated with one transformation, is trained independently on the training data set. By applying operations such as rotation and shear on the input, a transformation muddles the adversarial optimized pixels and therefore blocks the attack. A group of transformations, especially those from different categories, help in confusing adversarial perturbations introduced by different attacks by operating on the input in different ways. Therefore, an ensemble built on a group of diverse transformations (i.e., transformations from a variety of categories) tends to be more generally robust against various attacks.

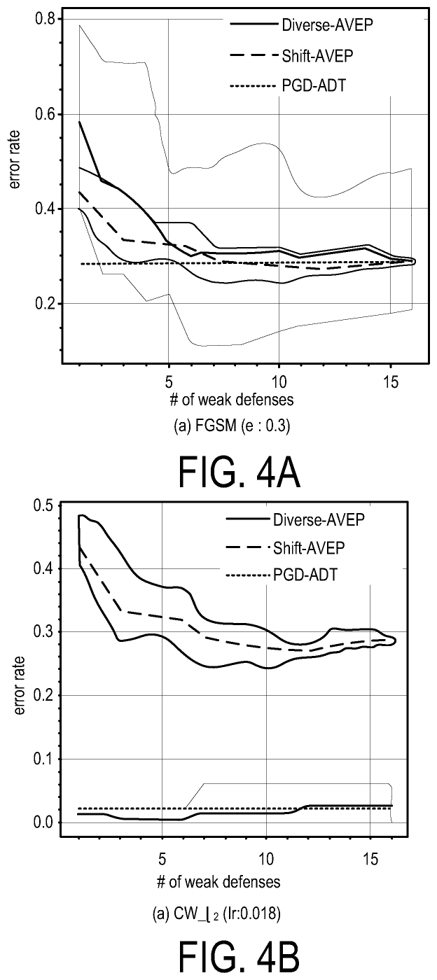

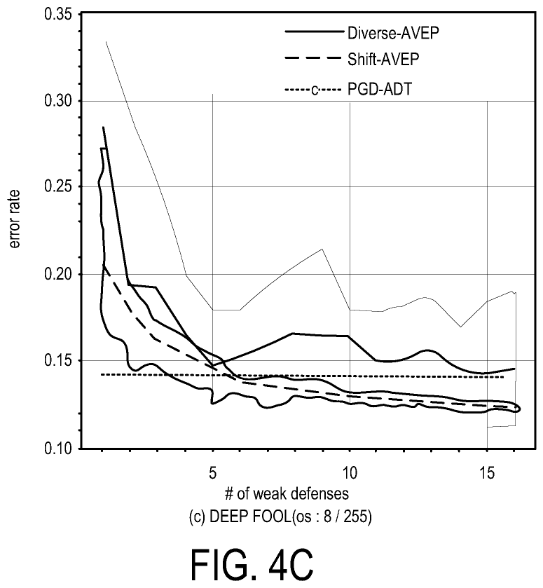

Utilizing the methodology of the present disclosure, evaluations of AVEP ensembles with various sizes have been performed where the average error rates and corresponding variations of 10 trials are presented in FIGS. 4A-4C. The ensembles were built with 2-6 random WDs 16 from two independent libraries: one consisting of 72 transformations from various categories, the other consists of 22 transformations from a single category (shift). The variations show the possible capabilities of the ensemble and the lower bound of the variations identifies the most effective ensemble that can be built with n WDs 16 (n=2; 3; : : : ; 16) from the given library. From FIGS. 4A-4C, it can be seen that for all examined attacks, a diverse library provides a larger variation with a smaller lower bound, where a potentially more robust ensemble could be found. Therefore, a library of many diverse transformations, which helps potentially build an effective ensemble, is desired.

The library [symbol] is constantly maintained by adding new WDs 16, and updating and removing ineffective or useless WDs 16.

Pre-process A preprocessing step 18 is performed to output the WDs 16 in the library [symbol] in a proper structure in order to come up with an efficient search in the transformation space that is scalable to large spaces. The library [symbol] of many diverse transformations is provided for a search to seek a non-empty subset of transformations in the WD selection step 22. However, the exponentially increasing size of the combitorial search space (i.e., size increases in O(2^{N}), where N is ensembled in in the library) will be limited to a small scale. For example, in the worst case, if the test on one combination costs 0:1 second, it will take more than 200 years for the combitorial search in a space of 30 WDs 16. Therefore, this preprocessing step 22 is desired.

There are many possible pre-processing techniques. For example, in one embodiment, WDs 16 are stored in a list. In one embodiment, the WDs 16 are grouped according to their transformation operations (e.g., rotation, shear, filter, etc.). Or, the WDs 16 can be clustered using a clustering algorithm, such as, for example, hierarchical clustering and k-means clustering. Graphlets may also be built in this step. Each graphlet is a combination of a few WDs 16 that form a diverse ensemble with a small size.

WD Selection In this step, a heuristic search is used to seek a subset of processed WDs 20 from the library ( [symbol] *). As discussed in the Library Maintenance section above, a diverse group of transformations offers a potential to construct an adversarial effective ensemble.

Therefore, measures like ensemble diversity and Shannon entropy etc., can serve as a metric in the search. Studies have shown that the ensemble's effectiveness can be improved by encouraging ensemble diversities.

Promoting ensemble diversity during training has resulted in improved ensemble effectiveness. Entropy measure of the outputs of individual WDs 16 has been used as a measure of the ensemble diversity and shown to improve a model's effectiveness.

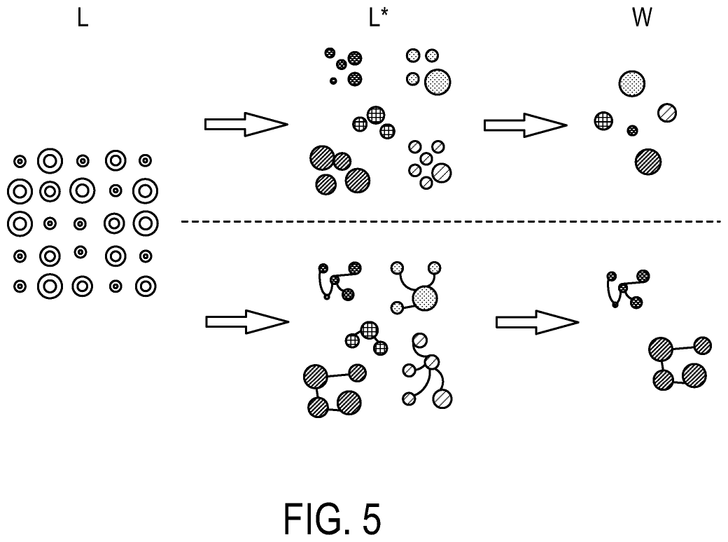

Search strategy is selected according to how the WDs 16 were represented in last step. For example, if the WDs 16 are simply maintained in a list, then a greedy best-first search can be applied. If the WDs 16 were clustered according to some similarity metric (e.g., distances between the inputs that have been applied on the transformations, distances between predictions on training set, etc.), in this step, the algorithm will seek a subset of WDs 16 across clusters (upper row in FIG. 5). If graphlets for small groups of diverse WDs 16 have been built, then a graphlet combination that leads to a diverse ensemble is searched for (bottom row in FIG. 5).

Learning Ensemble Strategy When the WDs W have been determined, an Ensemble Strategy (ES) 24 is then synthesized to take advantage of the selected WDs W. There are multiple ways to determine this strategy. One example is searching over the strategy space for an ES, such that this ES together with the W form an effective ensemble on training data set. The strategy space consists of some pre-defined strategies such as MV, AVEP, etc.

Another approach is to train a separate machine learning model, which takes the predictions from WDs 16 on input image x as input and produces a final prediction as output. Given a training data set [symbol] ′={([p_{1,1}, . . . , p̅_{n,1}], [symbol] ₁), . . . , ([p_{1,K}, . . . , p̅_{n,K}]i, [symbol] _{L})} with K training examples, where p_{i;j} is the vector of probabilities of all classes produced by the i-th WD on xⱼ, xⱼ is an example in training set D, and yⱼ is the true label of ₓⱼ, the model is trained by solving an optimization to minimize the loss function:

min( [symbol] (S(p),y)), (6)

where S(p) is the strategy model to produce the final output from predictions of WDs 16. There are many possible implementations for S(p). For example, a linear combination of predictions from WDs 16:

S(p)=Σᵢ₌₁ⁿw′ᵢpᵢ+b′ᵢ (7)

where pᵢ is the vector of predicted probabilities returned by the i-th WD on x, and w′ᵢ and b′ᵢ are the corresponding weight and bias of pᵢ.

Once the strategy is determined, together with W, an ensemble defense is formed and ready to be deployed.

Monitoring and Feedback A monitoring and feedback mechanism 26 is used to observe and estimate the performance of the ensemble at the deployment stage, see FIG. 3A and FIG. 3B. In one embodiment, this sub-system consists of three components—a monitor, a judge, and a messenger. The monitor keeps an eye on the ensemble after it is deployed and collects input-prediction pairs over a given period. The collected data will then be used by the judge to evaluate how well the ensemble works during the given period.

There are many ways to estimate the model's run-time performance. For example, in one embodiment, if an ensemble for lung cancer classification has been synthesized and deployed, the monitor collects the input-prediction pairs during a period and then asks the judge (e.g., a doctor or a group of doctors) to review a random subset of the collected input-prediction pairs. The judge then scores the run-time performance and asks for re-synthesis if the performance was not optimal.

In another embodiment, a model can be trained that computes the distribution of the collected input data, and then compares the run-time input distribution with the distribution of training set. If the distance is greater than the threshold, then the judge model outputs a signal and triggers the synthesis of the ensemble. During re-synthesis, the collected data will be used as part of the training data.

FIG. 5. shows sample pre-processing cases in accordance with embodiments of the present disclosure.

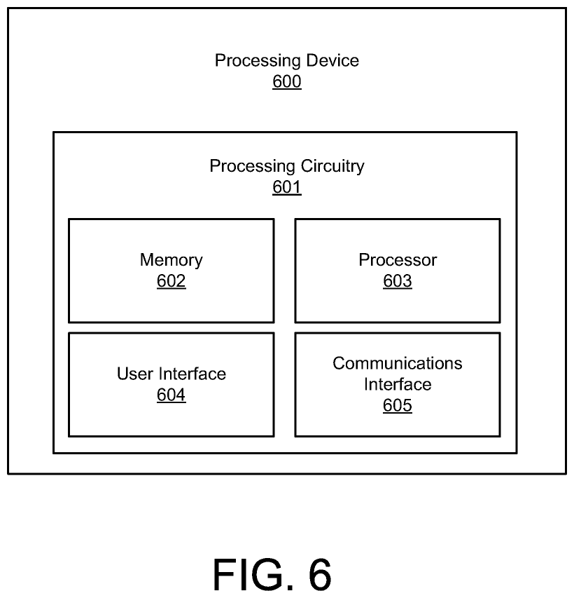

The methodology of the present disclosure may be implemented by a processing device 600 as shown in FIG. 6. Processing device 600 may comprise processing circuitry 601, which may be configured to receive inputs and provide outputs in association with the various functionalities of processing device 600. In this regard, processing circuitry 601 may comprise, for example, a memory 602, a processor 603, a user interface 604, and a communications interface 605. Processing circuitry 601 may be operably coupled to other components of processing device 600 or other components of a device that comprises processing device 600.

Further, according to some example embodiments, processing circuitry 601 may be in operative communication with or embody, memory 602, processor 603, user interface 604, and communications interface 605. Through configuration and operation of memory 602, processor 603, user interface 604, and communications interface 605, processing circuitry 601 may be configurable to perform various operations as described herein. In this regard, processing circuitry 601 may be configured to perform computational processing, memory management, user interface control and monitoring, and manage remote communications, according to exemplary embodiments. In other words, processing circuitry 601 may comprise one or more physical packages (e.g., chips) including materials, components or wires on a structural assembly (e.g., a baseboard). Processing circuitry 601 may be configured to receive inputs (e.g., via peripheral components), perform actions based on the inputs, and generate outputs (e.g., for provision to peripheral components). In an example embodiment, processing circuitry 601 may include one or more instances of processor 603, associated circuitry, and memory 602. As such, processing circuitry 601 may be embodied as a circuit chip (e.g., an integrated circuit chip, such as a field programmable gate array (FPGA)) configured (e.g., with hardware, software or a combination of hardware and software) to perform operations described herein.

In an example embodiment, memory 602 may include one or more non-transitory memory devices such as, for example, volatile or non-volatile memory that may be either fixed or removable. Memory 602 may be configured to store information, data, applications, instructions or the like. Memory 602 may operate to buffer instructions and data during operation of processing circuitry 601 to support higher-level functionalities, and may also be configured to store instructions for execution by processing circuitry 601. Memory 602 may also store image data, equipment data, crew data, and a virtual layout as described herein. According to some example embodiments, such data may be generated based on other data and stored or the data may be retrieved via communications interface 605 and stored.

As mentioned above, processing circuitry 601 may be embodied in a number of different ways. For example, processing circuitry 601 may be embodied as various processing means such as one or more processors 603 that may be in the form of a microprocessor or other processing element, a coprocessor, a controller or various other computing or processing devices including integrated circuits such as, for example, an ASIC (application specific integrated circuit), an FPGA, or the like. In an example embodiment, processing circuitry 601 may be configured to execute instructions stored in memory 602 or otherwise accessible to processing circuitry 601. As such, whether configured by hardware or by a combination of hardware and software, processing circuitry 601 may represent an entity (e.g., physically embodied in circuitry—in the form of processing circuitry 601) capable of performing operations according to example embodiments while configured accordingly. Thus, for example, when processing circuitry 601 is embodied as an ASIC, FPGA, or the like, processing circuitry 601 may be specifically configured hardware for conducting the operations described herein. Alternatively, as another example, when processing circuitry 601 is embodied as an executor of software instructions, the instructions may specifically configure processing circuitry 601 to perform the operations described herein.

All patents, patent applications, published applications, and publications, databases, websites and other published materials referred to throughout the entire disclosure herein, unless noted otherwise, are incorporated herein by reference in their entirety.

While the present subject matter has been described in detail with respect to specific exemplary embodiments and methods thereof, it will be appreciated that those skilled in the art, upon attaining an understanding of the foregoing may readily produce alterations to, variations of, and equivalents to such embodiments. Accordingly, the scope of the present disclosure is by way of example rather than by way of limitation, and the subject disclosure does not preclude inclusion of such modifications, variations and/or additions to the present subject matter as would be readily apparent to one of ordinary skill in the art using the teachings disclosed herein.

Many different embodiments have been disclosed herein, in connection with the above description and the drawings. It will be understood that it would be unduly repetitious and obfuscating to literally describe and illustrate every combination and subcombination of these embodiments. Accordingly, all embodiments can be combined in any way and/or combination, and the present specification, including the drawings, shall be construed to constitute a complete written description of all combinations and subcombinations of the embodiments described herein, and of the manner and process of making and using them, and shall support claims to any such combination or subcombination.

It will be appreciated by persons skilled in the art that the embodiments described herein are not limited to what has been particularly shown and described herein above. In addition, unless mention was made above to the contrary, it should be noted that all of the accompanying drawings are not to scale. A variety of modifications and variations are possible in light of the above teachings.

What is claimed is:

1. A method to run and dynamically adjust ensembles of defenses for adversarial attacks on AI systems comprising dynamically learning ensemble strategies and dynamically re-deploying new ensemble strategies based on a change of behavior of users monitoring of the ensemble defense.

2. A method for synthesizing adaptive defenses of artificial intelligence (AI) systems against adversarial attacks, the method comprising:
during a design phase,
creating a library of weak defenses (WDs);
preprocessing the WDs in the library;
selecting a subset W of WDs from the WDs in the library; and
during a deployment phase,
synthesizing an ensemble strategy based on an input of the selected subset W of WDs, the ensemble strategy used as a defense against adversarial attacks.

3. The method of claim 2, further comprising, in the deployment phase, monitoring, via a monitoring and feedback mechanism, a run-time performance of the defense.

4. The method of claim 2, further comprising re-synthesizing the ensemble.

5. The method of claim 2, wherein the WDs are discovered dynamically.

6. The method of claim 2, wherein the WDs are selected dynamically.

7. The method of claim 2, further comprising maintaining the library of WDs by at least one of adding new WDs, updating existing WDs and removing ineffective WDs.

8. The method of claim 2, wherein preprocessing the WDs comprises grouping the WDs in accordance with their transformation operations.

9. The method of claim 2, wherein prepreocessing the WDs comprises storing the WDs in a list.

10. The method of claim 2, wherein preprocessing the WDs in the library comprises clustering the WDs in accordance with a clustering algorithm.

11. The method of claim 10, wherein the clustering algorithm is one of a hierarchical clustering or a k-means clustering.

12. The method of claim 2, wherein selecting a subset W of WDs from the WDs in the library comprises employing a heuristic search.

13. The method of claim 2, wherein selecting a subset W of WDs from the WDs in the library is dependent upon how the WDs in the library are preprocessed.

14. The method of claim 2, wherein the monitoring and feedback mechanism includes a monitor component, a judge component, and a messenger component.

15. A device for synthesizing adaptive defenses of artificial intelligence (AI) systems against adversarial attacks, the system including a processor and a memory, the memory containing instructions executable by the processor, the processor configured to:
during a design phase,
create a library of weak defenses (WDs);
preprocess the WDs in the library;
select a subset W of WDs from the WDs in the library; and
during a deployment phase,
synthesize an ensemble strategy based on an input of the selected subset W of WDs, the ensemble strategy used as a defense against adversarial attacks.

16. The device of claim 15, wherein the processor is further configured to, in the deployment phase, monitor, via a monitoring and feedback mechanism, a run-time performance of the defense.

17. The device of claim 16, wherein the processor is further configured to re-synthesize the ensemble.

18. The device of claim 16, wherein the WDs are discovered dynamically.

19. The device of claim 16, wherein the WDs are selected dynamically.

20. The device of claim 16, wherein the processor is further configured to maintain the library of WDs by at least one of adding new WDs, updating existing WDs and removing ineffective WDs.

21. The device of claim 16, wherein preprocessing the WDs comprises grouping the WDs in accordance with their transformation operations.

22. The device of claim 16, wherein prepreocessing the WDs comprises storing the WDs in a list.

23. The device of claim 16, wherein preprocessing the WDs in the library comprises clustering the WDs in accordance with a clustering algorithm.

24. The device of claim 23, wherein the clustering algorithm is one of a hierarchical clustering or a k-means clustering.

25. The device of claim 16, wherein selecting a subset W of WDs from the WDs in the library comprises employing a heuristic search.

26. The device of claim 16, wherein selecting a subset W of WDs from the WDs in the library is dependent upon how the WDs in the library are preprocessed.

27. The device of claim 16, wherein the monitoring and feedback mechanism includes a monitor component, a judge component, and a messenger component.
